(19) United States
(12) Patent Application Publication
(10) Pub. No.: US 2022/0272982 A1
(43) Pub. Date: Sep. 1, 2022

(54) METAL ORGANIC FRAMEWORKS COMPRISING COPPER IONS AND PROCESSES FOR PREPARING SAME

(71) Applicants: RJ Lee Group, Inc., Monroeville, PA (US); UT-BATTELLE, LLC, Oak Ridge, TN (US); IOWA STATE UNIVERSITY RESEARCH FOUNDATION, INC., Ames, IA (US)

(72) Inventors: Steven J. Monaco, Venetia, PA (US); Richard J. Lee, Murrysville, PA (US); Alan M. Levine, Monroeville, PA (US); Jonathan Lyle Wistrom, Maryville, MO (US); Mariappan Parans Paranthaman, Knoxville, TN (US); Merlin Theodore, Knoxville, TN (US); Bryan Howard Bellaire, Ankeny, IA (US); Nathan Drew Peroutka-Bigus, Ames, IA (US)

(21) Appl. No.: 17/651,205

(22) Filed: Feb. 15, 2022

Related U.S. Application Data
(60) Provisional application No. 63/200,113, filed on Feb. 15, 2021.

(51) Int. Cl. A01N 59/20; C07F 1/08; A01N 25/10; A01N 25/34; A01P 1/00

(52) U.S. Cl. CPC A01N 59/20; C07F 1/08; A01N 25/10; A01N 25/34; A01P 1/00

(57) ABSTRACT

Provided is a metal organic framework (MOF) comprising copper ions. Also provided are resin powders, granules or pellets comprising the MOF. In some embodiments, the resin powders, granules or pellets are antimicrobial. Also provided are fibers or sheets comprising the MOF. In some embodiments, the fibers or sheets are antimicrobial. Processes for preparing the MOF are also provided.

### CROSS REFERENCE TO RELATED APPLICATIONS

This application claims priority to U.S. Provisional Patent Application Ser. No. 63/200,113, filed Feb. 15, 2021, entitled “Metal Organic Frameworks Comprising Copper Ions and Processes for Preparing Same”.

### GOVERNMENT LICENSE RIGHTS

This invention was made with government support under contract no. DE-AC05-00OR22725 awarded by the United States Department of Energy. The government has certain rights in the invention.

### FIELD OF THE INVENTION

Metal organic frameworks comprising copper ions are provided. Also provided are processes for preparing the metal organic frameworks.

### BACKGROUND OF THE INVENTION

U.S. Pat. No. 8,507,644 describes methods of making metal-terephthalate polymers. It describes a chemical reaction between terephthalic acid and a metal oxide, such as zinc oxide or magnesium oxide.

U.S. Pat. No. 2,465,319 describes a method of forming terephthalate glycol esters by heating glycols with terephthalic acid.

The current processes for making polymers comprising copper involve the use of copper or copper(II) oxide nanoparticles imbedded in polypropylene through melt blended processes. Nano- or micro-copper particles are incorporated into plastic by simple dispersion. The nano- or micro-copper particles are large and are prone to pull-out or significant leaching.

There remains a need for metal organic frameworks (MOFs) comprising copper ions and processes for preparing the MOFs.

### SUMMARY OF THE INVENTION

Provided is a metal organic framework (MOF) comprising copper ions.

In some embodiments, the copper ions are Cu2+.

In some embodiments, the copper ions are complexed with a terephthalate or a terephthalate ester.

In some embodiments, the terephthalate ester is a terephthalate glycol ester. In further embodiments, the terephthalate glycol ester is terephthalate ethylene glycol ester or terephthalate propylene glycol ester.

In some embodiments, the copper ions are complexed with a maleate.

In some embodiments, the maleate is a copolymer of maleic acid or maleic anhydride with an alpha olefin. In some embodiments, the maleate is a copolymer of maleic acid with an alpha olefin. In some embodiments, the maleate is poly[ethylene-alt-maleic acid], poly[propylene-alt-maleic acid], polyethylene-graft-maleic acid, or polypropylene-graft-maleic acid. In some embodiments, the maleate is derived from maleic anhydride-grafted polypropylene (alternatively named polypropylene-graft-maleic anhydride), maleic anhydride-grafted polyethylene (alternatively named polyethylene-graft-maleic anhydride), poly[ethylene-alt-maleic anhydride], or poly[propylene-alt-maleic anhydride]. In some embodiments, the maleate is chosen from a copolymer of maleic acid and polyethylene and a copolymer of maleic acid and polypropylene.

In some embodiments, the maleate is maleic anhydride-grafted polypropylene or maleic anhydride-grafted polyethylene.

In some embodiments, the maleate is maleic acid-grafted polypropylene (alternatively named polypropylene-graft-maleic acid) or maleic acid-grafted polyethylene (alternatively named polyethylene-graft-maleic acid).

In some embodiments, the copper ions are complexed to a maleate and a terephthalate or terephthalate ester simultaneously.

In some embodiments, the MOF further comprises copper atoms.

Also provided is a resin powder, granule or pellet comprising the MOF of any one of the previous embodiments. In some embodiments, the resin powder, granule or pellet is antimicrobial.

Provided is a fiber comprising the MOF of any one of the previous embodiments. In some embodiments, the fiber is antimicrobial. In further embodiments, the fiber is woven or non-woven.

Provided is a sheet comprising the MOF of any one of the previous embodiments. In some embodiments, the fiber is antimicrobial.

Provided is a composition comprising the MOF of any one of the previous embodiments blended with a polymer.

Provided is a composition comprising the MOF of any one of the previous embodiments blended with a plastic. In some embodiments, the plastic is polyester, polyethylene or polypropylene.

Provided is a process for preparing an MOF comprising copper ions, said process comprising: reacting a copper(II) terephthalate and maleic anhydride-grafted polypropylene, maleic anhydride-grafted polyethylene, poly[ethylene-alt-maleic anhydride], or poly[propylene-alt-maleic anhydride].

Provided is a process for preparing an MOF comprising copper ions, said process comprising: reacting a copper(II) terephthalate and maleic acid-grafted polypropylene, maleic acid-grafted polyethylene, poly[ethylene-alt-maleic acid], or poly[propylene-alt-maleic acid].

Provided is a process for preparing an MOF comprising copper ions, said process comprising: reacting a copper(II) terephthalate ester and maleic anhydride-grafted polypropylene, maleic anhydride-grafted polyethylene, poly[ethylene-alt-maleic anhydride], or poly[propylene-alt-maleic anhydride].

Provided is a process for preparing an MOF comprising copper ions, said process comprising: reacting a copper(II) terephthalate ester and maleic acid-grafted polypropylene, maleic acid-grafted polyethylene, poly[ethylene-alt-maleic acid], or poly[propylene-alt-maleic acid].

In some embodiments, the copper(II) terephthalate ester is prepared by reacting copper(II) terephthalate with a glycol. In further embodiments, the glycol is ethylene glycol or propylene glycol.

Provided is a process for preparing an MOF comprising copper ions, said process comprising the step of reacting a copper(II) source and a maleate copolymer.

Also provided is the product provided by a process comprising the step of reacting a copper(II) source and a maleate copolymer.

Also provided is a process for preparing a material comprising copper(II) terephthalate, or a derivative thereof, and ethylene glycol, or a derivative thereof, the process comprising the step of heating copper(II) terephthalate with an excess of ethylene glycol. In some embodiments, the process further comprises a successive step of reacting the material and a maleate copolymer.

Also provided is the product provided by a process comprising the step of heating copper(II) terephthalate with an excess of ethylene glycol. In some embodiments, the process further comprises a successive step of reacting the material and a maleate copolymer.

### BRIEF DESCRIPTION OF THE DRAWINGS

A full understanding of the invention can be gained from the following description of the preferred embodiments when read in conjunction with the accompanying drawings in which:

FIG. 1 depicts antiviral activity against the SARS-CoV-2 Washington variant (i) 6 hr (ii) 24 hr; (a) control, virus only (b) control with PP (c) Cu-m-PP (d) Cu-TP-m-PP; vertical axis=TCID50. N.D.=not detected.

### DETAILED DESCRIPTION OF THE INVENTION

Provided is a metal organic framework (MOF) comprising copper ions.

In some embodiments, the copper ions are Cu2+.

In some embodiments, the copper ions are complexed with a terephthalate or a terephthalate ester.

In some embodiments, the terephthalate ester is a terephthalate glycol ester. In further embodiments, the terephthalate glycol ester is terephthalate ethylene glycol ester or terephthalate propylene glycol ester.

In some embodiments, the copper ions are complexed with a maleate.

In some embodiments, the maleate is a copolymer of maleic acid or maleic anhydride with an alpha olefin.

In some embodiments, the maleate is maleic anhydride-grafted polypropylene, maleic anhydride-grafted polyethylene, poly[ethylene-alt-maleic anhydride], or poly[propylene-alt-maleic anhydride].

In some embodiments, the maleate is maleic acid-grafted polypropylene, maleic acid-grafted polyethylene, poly [ethylene-alt-maleic acid], or poly[propylene-alt-maleic acid].

Provided is a process for preparing an MOF comprising copper ions, said process comprising the step of reacting a copper(II) source and a maleate copolymer.

Also provided is the product provided by a process comprising the step of reacting a copper(II) source and a maleate copolymer.

In some embodiments, the maleate copolymer is maleic anhydride-grafted polypropylene, maleic anhydride-grafted polyethylene, poly[ethylene-alt-maleic anhydride], or poly[propylene-alt-maleic anhydride].

In some embodiments, the maleate copolymer is maleic acid-grafted polypropylene, maleic acid-grafted polyethylene, poly[ethylene-alt-maleic acid], or poly[propylene-alt-maleic acid].

In some embodiments, the copper(II) source is copper(II) oxide. In some embodiments, the copper(II) source is copper(II) hydroxide. In some embodiments, the copper(II) source is a copper(II) halide. In some embodiments, the copper(II) source is an ammoniacal solution of a copper(II) hydroxide or salt. In some embodiments, the copper(II) source is introduced in a solution prepared from aqueous ammonium hydroxide. In some embodiments, the copper(II) source is introduced in a solution prepared from concentrated aqueous ammonium hydroxide.

In some embodiments, the mass ratio of copper in the copper(II) source to maleic anhydride-grafted polymer is less than 0.03. In some embodiments, the mass ratio is less than 0.03. In some embodiments, the mass ratio is between 0.05 and 0.15. In some embodiments, the mass ratio is between 0.05 and 0.10. In some embodiments, the mass ratio is 0.05±0.01. In some embodiments, the mass ratio is 0.05±0.002.

In some embodiments, less than 500 g of the maleate copolymer is used. In some embodiments, less than 200 g of the maleate copolymer is used. In some embodiments, less than 150 g of the maleate copolymer is used.

In some embodiments, the copper(II) source and the maleate copolymer are reacted in the absence of solvent. In some embodiments, the copper(II) source and the maleate copolymer are reacted initially as solids. In some embodiments, the copper(II) source and the maleate copolymer are reacted in the melt.

In some embodiments, the mixture of the copper(II) source and the maleate copolymer is heated to a final temperature between 150° C. and 180° C. In some embodiments, the mixture is heated to a final temperature between 160° C. and 180° C. In some embodiments, the mixture is heated to a final temperature between 165° C. and 180° C. In some embodiments, the mixture is heated to a final temperature of about 170° C. In some embodiments, the mixture is heated to a final temperature of 170° C.±5° C.

In some embodiments, the reaction mixture of the copper(II) source and the maleate copolymer is held at the final temperature for a period between 30 min and 240 min. In some embodiments, the reaction is held at the final temperature for a period between 60 min and 210 min. In some embodiments, the reaction is held at the final temperature for a period between 60 min and 210 min. In some embodiments, the reaction is held at the final temperature for a period between 75 min and 180 min. In some embodiments, the reaction is held at the final temperature for a period between 90 min and 150 min. In some embodiments, the reaction is held at the final temperature for a period between 105 min and 135 min. In some embodiments, the reaction is held at the final temperature for a period between 110 min and 130 min.

In some embodiments, the reaction mixture of the copper(II) source and the maleate copolymer is rapidly quenched after completion of the heating process. In some embodiments, the heating and quenching steps are repeated under essentially the same conditions for a total of two cycles. In some embodiments, the heating and quenching steps are repeated under essentially the same conditions for a total of three cycles.

In some embodiments, the product of the reaction of the copper(II) source and the maleate copolymer has a melting point of 145° C. or higher. In some embodiments, the product has a melting point of 150° C. or higher. In some embodiments, the product has a melting point of 152° C. or higher. In some embodiments, the product has a melting point of 154° C. or higher.

Also provided is a process for preparing a material comprising copper(II) terephthalate, or a derivative thereof, and ethylene glycol, or a derivative thereof, the process comprising the step of heating copper(II) terephthalate with an excess of ethylene glycol. In some embodiments, the process further comprises a successive step of reacting the material and a maleate copolymer.

Also provided is the product provided by a process comprising the step of heating copper(II) terephthalate with an excess of ethylene glycol. In some embodiments, the process further comprises a successive step of reacting the material and a maleate copolymer.

In some embodiments, the copper(II) terephthalate is purified prior to reaction. In some embodiments, the copper(II) terephthalate is ground to 25 mesh before combination with ethylene glycol. In some embodiments, copper(II) terephthalate, when mixed with an excess of ethylene glycol, provides a black slurry. In some embodiments, the mixture of copper(II) terephthalate and ethylene glycol is heated to a final temperature between 150° C. and 190° C. In some embodiments, the mixture of copper(II) terephthalate and ethylene glycol is heated to a final temperature between 160° C. and 195° C. In some embodiments, the mixture of copper(II) terephthalate and ethylene glycol is heated to a final temperature between 170° C. and 190° C. In some embodiments, the reaction is held at the final temperature for a period between 150 min and 540 min. In some embodiments, the reaction is held at the final temperature for a period between 210 min and 480 min. In some embodiments, the reaction is held at the final temperature for a period between 270 min and 450 min. In some embodiments, the reaction is held at the final temperature for a period between 300 min and 420 min. In some embodiments, the reaction is held at the final temperature for a period between 330 min and 390 min. In some embodiments, the reaction is diluted with isopropanol after completion of the heating. In some embodiments, the solid product is collected by filtration. In some embodiments, the solid product that is formed is collected by centrifugation. In some embodiments, the solid product is rinsed with isopropanol and collected with filtration or centrifugation. In some embodiments, the isopropanol rinse and collection steps are repeated for a total of two cycles. In some embodiments, the isopropanol rinse and collection steps are repeated for a total of two or more cycles. In some embodiments, the solid product is dried after collection. In some embodiments, the solid product is dried at 140° C. or lower after collection. In some embodiments, the solid product is dried at 120° C. or lower after collection. In some embodiments, the solid product is dried at 100° C. or lower after collection. In some embodiments, the solid product has a blue-green or turquoise appearance.

In some embodiments, the product from the reaction between copper(II) terephthalate with an excess of ethylene glycol (“terephthalate/glycol product”) is further reacted with a maleate copolymer. In some embodiments, less than 500 g of the terephthalate/glycol product is used. In some embodiments, less than 200 g of the terephthalate/glycol product is used. In some embodiments, less than 150 g of the terephthalate/glycol product is used.

In some embodiments, the copper(II) source and the terephthalate/glycol product are reacted in the absence of solvent. In some embodiments, the copper(II) source and the terephthalate/glycol product are reacted initially as solids. In some embodiments, the copper(II) source and the terephthalate/glycol product are reacted in the melt.

In some embodiments, the mixture of the copper(II) source and the terephthalate/glycol product is heated to a final temperature between 150° C. and 180° C. In some embodiments, the mixture is heated to a final temperature between 160° C. and 180° C. In some embodiments, the mixture is heated to a final temperature between 165° C. and 180° C. In some embodiments, the mixture is heated to a final temperature of about 170° C. In some embodiments, the mixture is heated to a final temperature of 170° C.±5° C.

In some embodiments, the reaction mixture of the copper(II) source and the terephthalate/glycol product is held at the final temperature for a period between 30 min and 240 min. In some embodiments, the reaction is held at the final temperature for a period between 60 min and 210 min. In some embodiments, the reaction is held at the final temperature for a period between 60 min and 210 min. In some embodiments, the reaction is held at the final temperature for a period between 75 min and 180 min. In some embodiments, the reaction is held at the final temperature for a period between 90 min and 150 min. In some embodiments, the reaction is held at the final temperature for a period between 105 min and 135 min. In some embodiments, the reaction is held at the final temperature for a period between 110 min and 130 min.

Also provided is a composition comprising the material of any one of the previous embodiments. In some embodiments, the composition is in the form of a resin powder, granule, or pellet. In some embodiments, the composition further comprises a polymer that is neither a maleate/alpha olefin copolymer nor a terephthalate/ethylene glycol copolymer. In some embodiments, the polymer is a plastic. In some embodiments, the plastic is chosen from a polyester, polyethylene, and polypropylene.

Also provided is a manufactured article comprising the material of any one of the previous embodiments. In some embodiments, the manufactured article is a fiber. In some embodiments, the manufactured article is a woven or non-woven fiber. In some embodiments, the manufactured article is a sheet. In some embodiments, the manufactured article is a film.

### Definitions

Unless defined otherwise, all technical and scientific terms used herein have the same meaning as is commonly understood by one of skill in the art to which this invention belongs. All publications and patents referred to herein are incorporated by reference.

As used herein, the articles “a” and “an” may refer to one or to more than one (e.g. to at least one) of the grammatical object of the article.

As used herein, “about” may generally refer to an acceptable degree of error for the quantity measured given the nature or precision of the measurements. Example degrees of error are within 5% of a given value or range of values.

Embodiments described herein as “comprising” one or more features may also be considered as disclosure of the corresponding embodiments “consisting of” and/or “consisting essentially of” such features.

Concentrations, amounts, volumes, percentages and other numerical values may be presented herein in a range format. It is also to be understood that such range format is used merely for convenience and brevity and should be interpreted flexibly to include not only the numerical values explicitly recited as the limits of the range but also to include all the individual numerical values or sub-ranges encompassed within that range as if each numerical value and sub-range is explicitly recited.

The term “alpha olefin”, as used herein, refers to a hydrocarbon containing a single terminal olefin. An alpha olefin therefore contains the structural fragment “H2C═CH—”. In some embodiments, the alpha olefin is a linear alpha olefin. In some embodiments, the alpha olefin has 12 carbons or fewer. In some embodiments, the alpha olefin has 10 carbons or fewer. In some embodiments, the alpha olefin has 8 carbons or fewer. In some embodiments, the alpha olefin has 6 carbons or fewer. In some embodiments, the alpha olefin has 4 carbons or fewer. In some embodiments, the alpha olefin has 3 carbons or fewer. In some embodiments, the alpha olefin is chosen from ethylene and propylene.

The term “antimicrobial”, as used herein, refers to a material that reduces the presence of microbes. In some embodiments, an antimicrobial is effective at killing microbes. In some embodiments, an antimicrobial is effective at reducing the spread of microbes. In some embodiments, an antimicrobial is effective at reducing the viability of microbes. In some embodiment, an antimicrobial is effective against one or more types of bacteria. In some embodiment, an antimicrobial is effective against one or more types of viruses. In some embodiment, an antimicrobial is effective against one or more types of protozoa. In some embodiment, an antimicrobial is effective against one or more types of fungi.

The term “copolymer”, as used herein, refers to a polymer comprising two or more non-identical monomers. The term therefore includes polyolefins derived from two or more types of olefins. By way of example only, the product from polymerization of ethylene and propylene is included in the definition of copolymer. Block copolymers are also included in the definition of copolymer.

As used herein, the term “maleate” is used to include both maleic acid and maleic anhydride, and compounds derived from maleic acid and/or maleic anhydride, including but not limited to copolymers formed by the reaction of an alpha olefin and either of maleic acid or maleic anhydride.

As used herein, the term metal-organic framework (“MOF”) refers to a material comprising metal ions and/or metal clusters and multiply-coordinating organic molecules. In some embodiments, the MOF forms one-dimensional coordination polymers. In some embodiments, the MOF forms two-dimensional coordination polymers. In some embodiments, the MOF forms three-dimensional coordination polymers. In some embodiments, the coordination polymer is comprised of metal ions, or clusters, alternating in space with multiply-coordinating organic molecules. In some embodiments, the coordination between the metal and organic molecule is ionic in nature.

As used herein, the term “polyethylene terephthalate” is an alternate designation for polyester ethylene terephthalate and “PET” is the acronym. When referencing terephthalic acid, “TPA” is the acronym. When referring to metal terephthalates the acronym uses “TPA.” For example, copper(II) terephthalate becomes Cu-TPA.

As used herein, “EG” refers to ethylene glycol. As used herein, “IPA” refers to isopropanol.

As used herein, m-PP refers to a copolymer of maleate and propylene.

As used herein, Cu-m-PP refers to a material comprising copper(II) and a copolymer of maleate and propylene.

As used herein, “PP” refers to polypropylene.

As used herein, “Cu-TP-m-PP” refers to the copper(II) ethylene glycol terephthalate ester and maleic anhydride-grafted polypropylene material as described in Example 2.

As used herein, “TCID50” refers to median tissue culture infectious dose.

### Metal-Organic Frameworks (MOFs)

The current art is to incorporate nano- or micro-copper particles into plastic by simple dispersion. The present invention incorporates copper into plastics by trapping the copper in a MOF structure and either retaining copper in such structures in ionic form or releasing it into the plastic as individual atoms. In these MOFs the copper is chemically bound and the size of the incorporated copper is on the order of 1,000 fold smaller and much more evenly dispersed than the current art describes. While micro and nano copper can be seen by high resolution electron microscopy, atomic and ionic copper is visible as an even dispersion. The copper is trapped and chemically bound within the chemical structure of the MOF and is less likely to leach into the surrounding environment.

Provided is a MOF comprising copper ions.

Also provided is a MOF comprising copper ions, wherein the copper ions are complexed between a carboxyl group from an alternating copolymer of an alpha olefin and maleic acid (“poly[alpha olefin-alt-maleic acid]”) and a carboxyl group from a terephthalate (1a). By way of example, in the case of R═H, the polymer is poly[ethylene-alt-maleic acid], in the case of R═CH3, the polymer is poly[propylene-alt-maleic acid], and in the case of R=Ph, the polymer is poly[styrene-alt-maleic acid]. Index “n” represents an integer, which need not be uniform throughout the material. The disclosure is intended to encompass all sizes, average molecular weights, and polydispersities for the polymer shown in (1a) and throughout.

It will be appreciated by a person of skill that the carboxylic acids (—COOH) in (1a) below and throughout the disclosure may also exist, either partially or completely, in the deprotonated state (—COO⁻). The disclosure is intended to encompass all protonation states for carboxylic acids in (1a) and throughout, unless otherwise explicitly indicated.

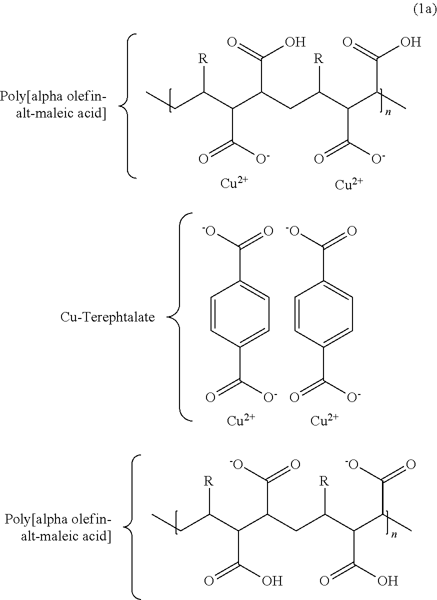

Also provided is a MOF comprising copper ions, wherein the copper ions are complexed between a carboxyl group from an graft copolymer of an alpha olefin and maleic acid (“poly(alpha olefin)-graft-maleic acid”) and a carboxyl group from a terephthalate (1b). By way of example, in the case of R═H, the polymer is polyethylene-graft-maleic acid, in the case of R═CH3, the polymer is polypropylene-graft-maleic acid, and in the case of R=Ph, the polymer is polystyrene-graft-maleic acid.

It will be appreciated by a person of skill that, due to the nature of the graft copolymer, two chemically nonequivalent carboxylic acids are present in any maleic acid monomer: (i) a carboxylic acid directly attached to the —CH— group connected to the polymer backbone, and (ii) a carboxylic acid containing an intervening —CH2— group. The disclosure envisions, at any given monomer, deprotonation of either carboxylic acid and coordination to the Cu2+ center, either uniformly throughout the polymer or randomly at each monomer. For simplicity and brevity, only carboxylic acid (i) is shown as deprotonated and coordinated to the Cu²⁺ center in (1b) and successive formulas. Furthermore, indices “m” and “n” represent integers, which may be the same or different, and which need not be uniform either throughout a bulk sample of material or a single polymer strand.

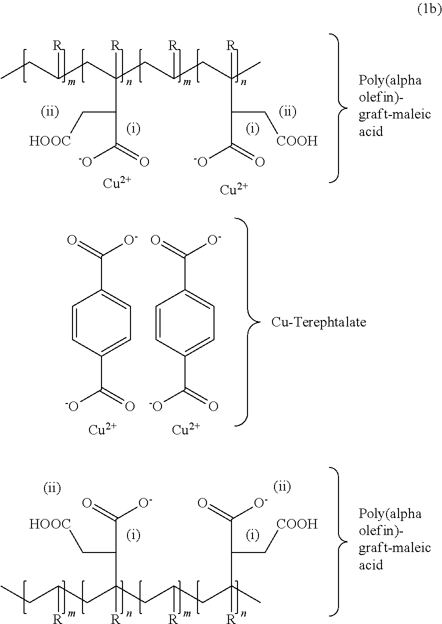

Also provided is a MOF comprising copper ions, wherein the copper ions are complexed between a carboxyl group from a poly[alpha olefin-alt-maleic acid] and a carboxyl group from a terephthalate ethylene glycol ester. Optionally, copper ions are also complexed between a carboxyl group from an adjacent poly[alpha olefin-alt-maleic acid] and a hydroxyl or alkoxide group of the terephthalate ethylene glycol ester (2a). It will be appreciated that the hydroxyl, shown for simplicity and brevity as the deprotonated alkoxide in (2a) and elsewhere, may also exist as the neutral, protonated, hydroxyl, in which case a counterion from the medium (either from a reaction mixture or intentionally added to the material) may satisfy charge neutrality. The disclosure is intended to encompass all protonation states for hydroxyls in (2a) and throughout, unless otherwise explicitly indicated.

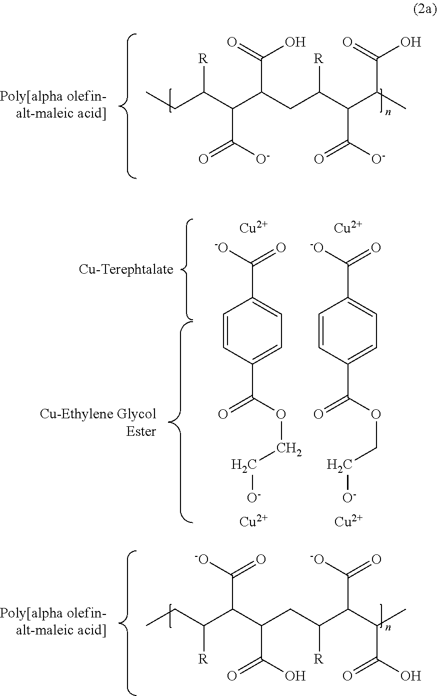

Also provided is a MOF comprising copper ions, wherein the copper ions are complexed between a carboxyl group from a poly(alpha olefin)-graft-maleic acid and a carboxyl group from a terephthalate ethylene glycol ester. Optionally, copper ions are also complexed between a carboxyl group from an adjacent a poly(alpha olefin)-graft-maleic acid and a hydroxyl or alkoxide group of the terephthalate ethylene glycol ester (2b).

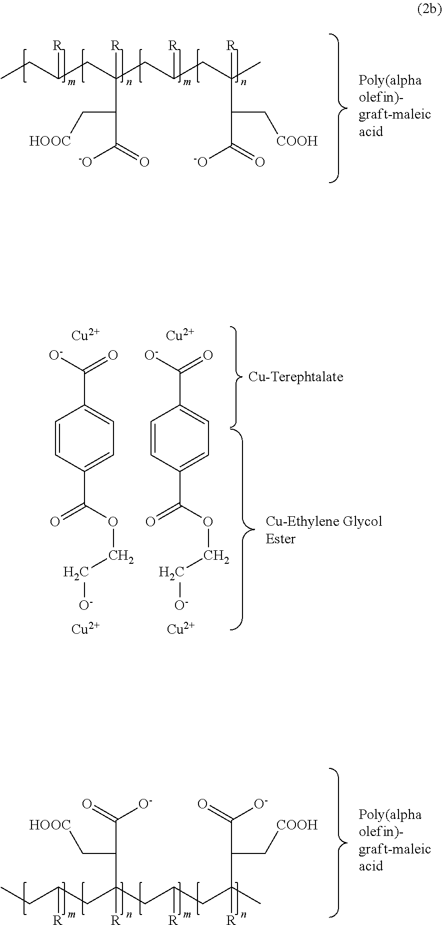

Also provided is a MOF comprising copper ions, wherein the copper ions are complexed between a carboxyl group from a poly[alpha olefin-alt-maleic acid] and a hydroxyl or alkoxide group from a terephthalate ethylene glycol ester (3a).

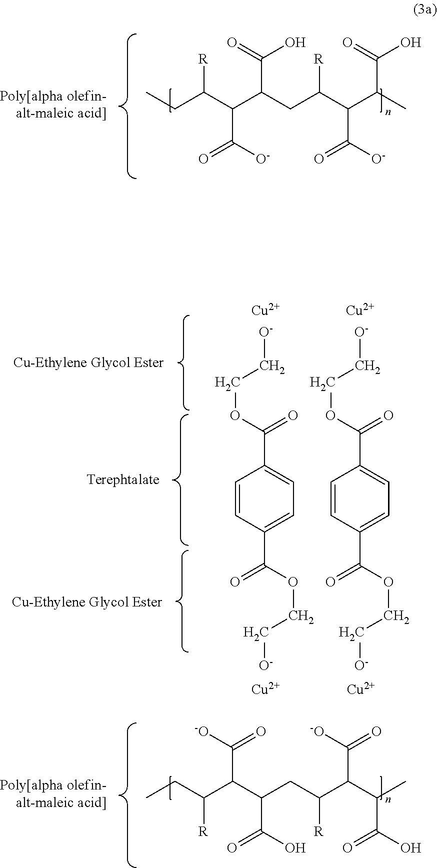

Also provided is a MOF comprising copper ions, wherein the copper ions are complexed between a carboxyl group from a poly(alpha olefin)-graft-maleic acid and a hydroxyl or alkoxide group from a terephthalate ethylene glycol ester (3b).

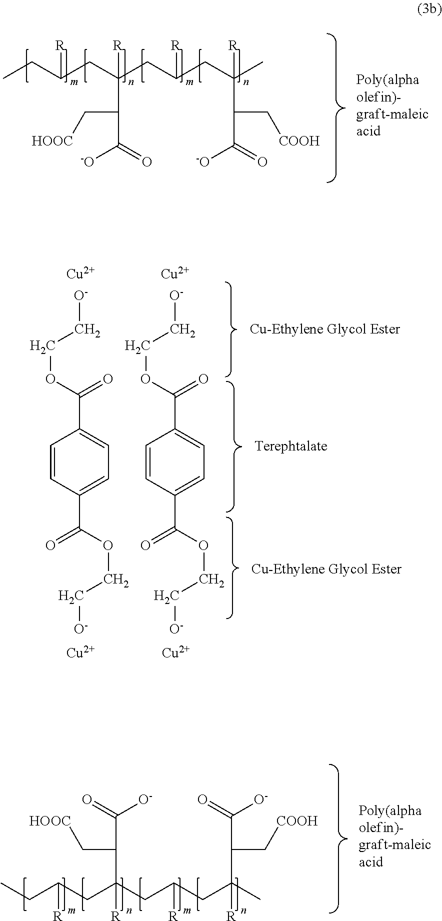

Also provided is a MOF comprising copper ions, wherein the copper ions are complexed between two carboxyl groups from adjacent strands of poly[alpha olefin-alt-maleic acid]. (4a).

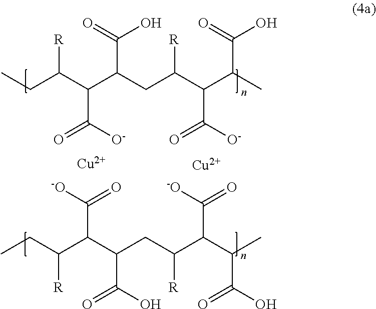

Also provided is a MOF comprising copper ions, wherein the copper ions are complexed between two carboxyl groups from adjacent strands of poly(alpha olefin)-graft-maleic acid. (4b).

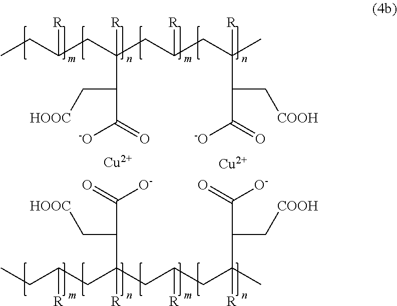

Also provided is a MOF comprising copper ions, wherein the copper ions are complexed between a carboxyl group from a poly[alpha olefin-alt-maleic acid] and 4,4′-((ethane-1,2-diylbis(oxy))bis(carbonyl))dibenzoic acid (“ethylene glycol diester”) (5a). The ethylene glycol diester of terephthalic acid may be obtained by reaction of a limiting quantity of ethylene glycol with an excess of terephthalic acid under Fischer esterification conditions, or by using other esterification methods known in the art.

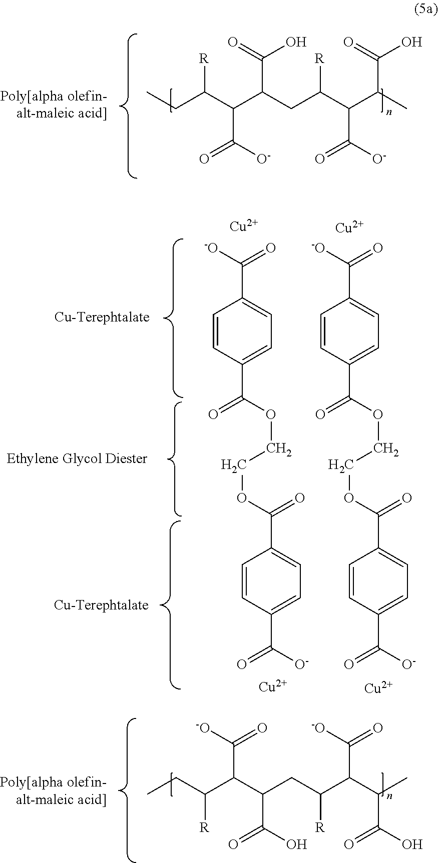

Also provided is a MOF comprising copper ions, wherein the copper ions are complexed between a carboxyl group from a poly(alpha olefin)-graft-maleic acid and 4,4′-((ethane-1,2-diylbis(oxy))bis(carbonyl))dibenzoic acid (“ethylene glycol diester”) (5b). The ethylene glycol diester of terephthalic acid may be obtained by reaction of a limiting quantity of ethylene glycol with an excess of terephthalic acid under Fischer esterification conditions, or by using other esterification methods known in the art.

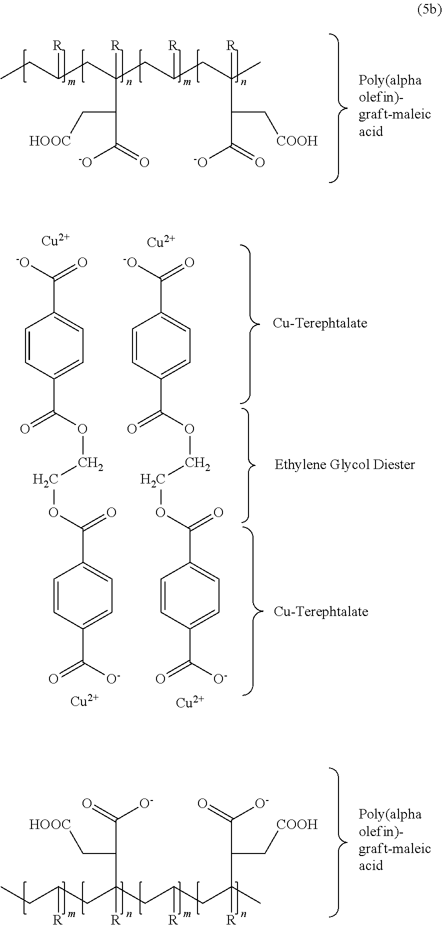

The materials disclosed herein may be obtained by admixture of an appropriate copper(II) source and a copolymer of a maleate with an alpha olefin. The materials may be obtained by procedures encompassed by the embodiments set forth herein. The materials may be obtained by procedures analogous to those disclosed by the Examples set forth below.

The maleate may be either of maleic acid or maleic anhydride. A person of skill will appreciate that the reaction of maleic anhydride with an alpha olefin may originally comprise anhydride functionalities. These anhydride functionalities may spontaneously hydrolyze under the polymerization reaction conditions, providing diacid functionalities directly. Alternatively, anhydride functionalities present in the product of the polymerization reaction may be intentionally hydrolyzed by treatment of the polymer with moisture, water, or alkaline water. Alternatively, these anhydride functionalities may react with copper(II) hydroxide or copper(II) oxide to provide diacid functionalities. These reactions may be performed in the presence of ambient moisture, or may be performed in the presence of water.

In any one of the previous embodiments, the MOF may further comprise copper atoms.

The MOF can be incorporated into any master batch material for adjusting formulations. Provided is a resin powder, granule or pellet comprising the MOF of any one of the previous embodiments. In some embodiments, the resin powder, granule or pellet is antimicrobial. In some embodiments, a plastic comprising the MOF is extruded through a die and cut into short pieces and cooled rapidly. In further embodiments, the pieces may be further processed to alter their size and/or shape.

Provided is a fiber comprising the MOF of any one of the previous embodiments. In some embodiments, the fiber is antimicrobial. In further embodiments, the fiber is woven or non-woven. Any method for making fibers out of a plastic may be employed for making fibers comprising the MOF of any one of the previous embodiments. In some embodiments, fibers are extruded from a melt through a die.

Provided is a sheet comprising the MOF of any one of the previous embodiments. In some embodiments, the sheet is antimicrobial. Any method for making plastic sheets may be employed for making sheets comprising the MOF of any one of the previous embodiments. In some embodiments, a sheet is woven or non-woven. In further embodiments, the sheet is non-woven and comprises fibers that are bonded together. In yet further embodiments, the fibers that are bonded together may have the same length or may have different lengths, or combinations thereof.

Provided is a composition comprising the MOF of any one of the previous embodiments blended with a polymer.

Provided is a composition comprising the MOF of any one of the previous embodiments blended with a plastic. Any method for blending plastic may be employed for making the composition comprising the MOF of any one of the previous embodiments blended with a plastic. In some embodiments, the plastic blending is done in a high shear screw mixer or extruder. In some embodiments, the plastic is polyester, polyethylene or polypropylene. In further embodiments, the composition is antimicrobial.

Processes For Preparing An MOF

Provided is a process for preparing an MOF comprising copper ions, said process comprising: reacting a copper(II) terephthalate and maleic anhydride-grafted polypropylene or maleic anhydride-grafted polyethylene.

In some embodiments, copper(II) terephthalate and maleic anhydride-grafted polypropylene react to form (1b).

Provided is a process for preparing an MOF comprising copper ions, said process comprising: reacting a copper(II) terephthalate and poly[propylene-alt-maleic anhydride] or poly[ethylene-alt-maleic anhydride].

In some embodiments, copper(II) terephthalate and poly[propylene-alt-maleic anhydride] react to form (1a).

Provided is a process for preparing an MOF comprising copper ions, said process comprising: reacting a copper(II) terephthalate ester and maleic anhydride-grafted polypropylene or maleic anhydride-grafted polyethylene. In some embodiments, the copper(II) terephthalate ester is prepared by reacting copper(II) terephthalate with a glycol. In further embodiments, the glycol is ethylene glycol or propylene glycol.

Provided is a process for preparing an MOF comprising copper ions, said process comprising: reacting a copper(II) terephthalate ester and poly[propylene-alt-maleic anhydride] or poly[ethylene-alt-maleic anhydride]. In some embodiments, the copper(II) terephthalate ester is prepared by reacting copper(II) terephthalate with a glycol. In further embodiments, the glycol is ethylene glycol or propylene glycol.

In some embodiments, copper(II) terephthalate and ethylene glycol react to form copper ethylene glycol terephthalate ester (copper polyethylene terephthalate) (5):

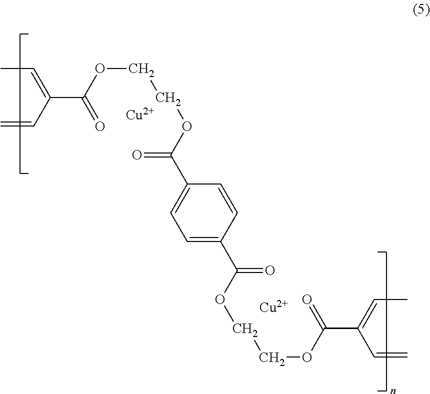

In some embodiments, copper ethylene glycol terephthalate ester and maleic anhydride-grafted polypropylene react to form (2b) or (3b) or mixtures thereof.

In some embodiments, copper ethylene glycol terephthalate ester and poly[propylene-alt-maleic anhydride] react to form (2a) or (3a) or mixtures thereof.

Provided is a process for preparing an MOF comprising copper ions, said process comprising: reacting copper(II) oxide and maleic anhydride-grafted polypropylene or maleic anhydride-grafted polyethylene.

In some embodiments, copper(II) oxide and maleic anhydride-grafted polyethylene react to form (4b).

In some embodiments, copper(II) oxide and poly[propylene-alt-maleic anhydride] react to form (4a).

Provided is a process for preparing an MOF comprising copper ions, said process comprising: reacting copper(II) hydroxide and maleic anhydride-grafted polypropylene or maleic anhydride-grafted polyethylene.

In some embodiments, copper(II) hydroxide and maleic anhydride-grafted polyethylene react to form (4b).

In some embodiments, copper(II) hydroxide and poly[propylene-alt-maleic anhydride] react to form (4a).

### EXAMPLES

### Example 1: Copper(H) Hydroxide and Maleic Anhydride-Grafted Polypropylene

Copper(II) hydroxide powder (Cu(OH)2) was physically mixed with ground maleic anhydride-grafted polypropylene powder (m-PP) (Sigma-Aldrich, St. Louis, Mo., Product #427845) at a ratio of 0.77 g Cu(OH)2:100 g m-PP to create a nominal 0.5 wt % Cu mixture and heated to 170° C. for 2 hr. A ratio of 0.5-1.5 g Cu(OH)2:100 g m-PP was found to be optimal, while ratios of 0-3.0 g Cu(OH)2:100 g m-PP were found to work. The melt mixture was then rapidly quenched to form a solid mass. This mass was then milled using a ball mill for 10 min, re-melted, and re-solidified twice, for a total of three melt-solidification cycles. It was important to melt the maleic anhydride-grafted polypropylene and allow the Cu(OH)2 to react with the maleic acid groups without turning the copper(II) hydroxide into copper(II) oxide. The melting point of the maleic anhydride-grafted polypropylene is approximately 156° C., while Cu(OH)2 decomposes to CuO at approximately 185° C.

In some trials, Cu(OH)2 in ammonia was used as a means to introduce the copper as a solution into the m-PP. An excess of copper(II) hydroxide was added to a concentrated ammonium hydroxide solution (28-30% NH3 basis) to create a saturated solution. An aliquot of the solution was mixed into the m-PP and then the mixture was processed as above (melted, ground, etc.). The copper concentration in the final product was then measured to establish the relationship between the liquid solution amount and the final wt % Cu in the MOF. Once the final wt % Cu in the MOF was known, the liquid:solid ratio was adjusted as needed to achieve the desired wt % Cu in the MOF.

### Example 2: Copper(H) Ethylene Glycol Terephthalate Ester and Maleic Anhydride-Grafted Polypropylene (“Cu-TP-m-PP”)

Copper(II) terephthalate powder can be generated using the methods taught in U.S. Pat. No. 8,507,644 or can be purchased from various vendors.

In order to purify the Copper(II) terephthalate, it was first ground to 25 mesh (707 μm) and mixed with an excess of ethylene glycol (EG) (Sigma-Aldrich, St. Louis, Mo., Product #102466) to form a black slurry. The slurry was heated to 180° C. for 6 hr in air, forming a blue-green/turquoise liquid (copper ethylene glycol terephthalate ester). The liquid was suspended in isopropanol (IPA) and filtered through a 100 mesh sieve (149 μm) to remove unreacted solids. The copper ethylene glycol terephthalate ester—IPA mixture was centrifuged to separate the IPA (plus excess ethylene glycol) from the copper ethylene glycol terephthalate ester. Additional IPA was mixed with the ester and the process repeated as needed until the EG was removed. The wet copper ethylene glycol terephthalate ester was dried at 120° C. The resultant blue-green/turquoise powder was sieved to 100 mesh.

U.S. Pat. No. 2,465,319 describes a method to form glycol esters by heating glycols with terephthalic acid. The patented method removes excess glycol by distillation and further heating above the boiling point of the glycol (197° C. for EG per Sigma-Aldrich, St. Louis, Mo.). Note that the melting point of pure terephthalic acid is >300° C. (per Sigma-Aldrich, St. Louis, Mo.). The method currently being described substitutes CuTPA for TPA. A lower temperature process was felt to be desirable in order to prevent oxidation of the Cu and thus the IPA method was developed. EG is soluble in IPA, while the Cu ethylene glycol terephthalate ester is not. Upon mixing and centrifugation, a two-phase mixture forms with the IPA and EG in the top layer and the Cu ethylene glycol terephthalate ester in the bottom layer.

The dried Cu ethylene glycol terephthalate ester was then added to m-PP powder and processed as in Example 1.

### Example 3: Antiviral Activity

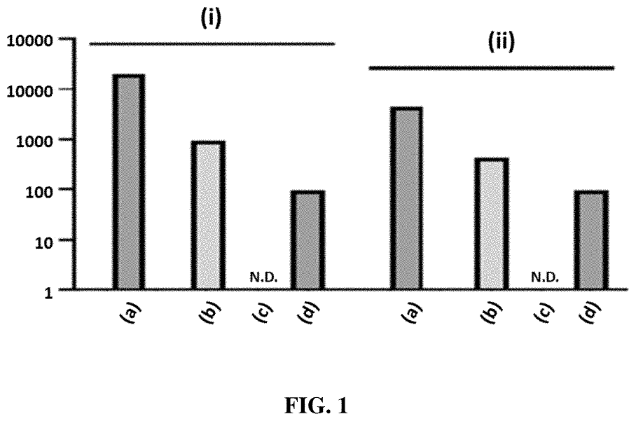

Antiviral activity was determined with a tissue culture infectivity assay using visual scoring of tissue clearing as a measure of viral load, based on a fluorometric reading for cells killed by the virus, after exposure to Cu—PP disks. Results are presented in FIG. 1.

All publications and patents referred to herein are incorporated by reference. Various modifications and variations of the described subject matter will be apparent to those skilled in the art without departing from the scope and spirit of the invention. Although the invention has been described in connection with specific embodiments, it should be understood that the invention as claimed should not be unduly limited to these embodiments. Indeed, various modifications for carrying out the invention are obvious to those skilled in the art and are intended to be within the scope of the following claims.

1. A metal organic framework (MOF) comprising copper ions.

2. The MOF of claim 1, wherein the copper ions are Cu²⁺.

3. The MOF of claim 1, wherein the copper ions are complexed with a terephthalate or terephthalate ester.

4. The MOF of claim 1, wherein the terephthalate ester is a terephthalate glycol ester.

5. The MOF of claim 4, wherein the terephthalate glycol ester is terephthalate ethylene glycol ester or terephthalate propylene glycol ester.

6. The MOF of claim 1, wherein the copper ions are complexed with a maleate.

7. The MOF of claim 6, wherein the maleate is chosen from poly[ethylene-alt-maleic acid], poly[propylene-alt-maleic acid], polyethylene-graft-maleic acid, and polypropylene-graft-maleic acid.

8. The MOF of claim 1, wherein the copper ions are complexed to a maleate and a terephthalate or terephthalate ester simultaneously.

9. A composition comprising the MOF of claim 1.

10. The composition of claim 9, in the form of a resin powder, granule, or pellet.

11. The composition of claim 9, wherein the resin powder, granule or pellet is antimicrobial.

12. The composition of claim 9, further comprising a polymer that is neither a maleate/alpha olefin copolymer nor a terephthalate/ethylene glycol copolymer.

13. The composition of claim 9, further comprising a plastic.

14. The composition of claim 12, further comprising a plastic chosen from a polyester, polyethylene, and polypropylene.

15. A manufactured article comprising the MOF of claim 1.

16. The manufactured article of claim 15, wherein the manufactured article is chosen from a fiber, a sheet, and a film.

17. The manufactured article of claim 15, wherein the manufactured article is a woven or non-woven fiber.

18. The manufactured article of claim 15, wherein the manufactured article is a sheet.

19. The manufactured article of claim 15, wherein the manufactured article is antimicrobial.

20. A process for preparing an MOF comprising copper ions, said process comprising reacting a copper(II) source with a maleate copolymer.

21. The process of claim 20, wherein the maleate copolymer is m-PP.

22. The process of claim 24, wherein the glycol is ethylene glycol or propylene glycol.

23. The process of claim 21, wherein the copper(II) source is copper(II) oxide.

24. The process of claim 21, wherein the copper(II) source is copper(II) hydroxide.

25. The process of claim 24, wherein the reaction mixture contains 0.5 wt % Cu.

26. The process of claim 25, wherein the reaction mixture is heated to 170° C. for 2 hr.

27. The process of claim 26, wherein the process further comprises the steps of:
quenching, thereby forming a solid mass; and
milling with a ball mill.

28. The process of claim 27, wherein the reaction mixture contains 100 g of m-PP.

29. The product obtained by the process of claim 24.

30. The process of claim 21, wherein the copper(II) source is a copper(II) terephthalate.

31. The process of claim 21, wherein the copper(II) source is a copper(II) terephthalate ester.

32. The process of claim 23, wherein the copper(II) terephthalate ester is prepared by reacting copper(II) terephthalate with a glycol.

33. The process of claim 32, wherein the reaction mixture is heated to 180° C. for 6 hr.

34. The process of claim 33, wherein the reaction is diluted with isopropanol after completion of the heating.

35. The process of claim 34, wherein the solid product that is formed is collected by centrifugation.

36. The process of claim 35, further comprising the steps of:
rinsing the solid product with isopropanol; and
collecting the solid product with centrifugation.

37. The process of claim 36, further comprising the step of reacting the product with m-PP.

38. The process of claim 37, wherein the reaction mixture is heated to 170° C. for 2 hr.

39. The process of claim 38, wherein the process further comprises the steps of:
quenching, thereby forming a solid mass; and
milling with a ball mill.

40. The product obtained by the process of claim 30.
